(19) United States
(12) Patent Application Publication
(10) Pub. No.: US 2008/0096042 A1
(43) Pub. Date: Apr. 24, 2008

(54) Process For The Preparation Of Metallic Wools With A Controlled Degree Of Surface Oxidation And Fibres Deriving From Them: Products Obtained, And Their Use As Supports To Obtain Metaalic Core Composite Materials For A Variety Of Applications

(75) Inventors: Paolo Carniti, Milano (IT); Antonella Gervasini, Milano (IT); Serena Biella, Milano (IT)

Correspondence Address: YOUNG & THOMPSON, 745 SOUTH 23RD STREET, 2ND FLOOR, ARLINGTON, VA, 22202, US

(73) Assignee: Universita' Degli Studi Di Milano, Milano (IT)

(21) Appl. No.: 11/665,149

(22) PCT Filed: Oct. 13, 2005
(86) PCT No.: PCT/EP05/11025

§ 371 Date: Jul. 11, 2007

(30) Foreign Application Priority Data
Oct. 15, 2004 (IT) MI2004A001964
Jul. 22, 2005 (EP) 05015937.5

(51) Int. Cl. B23P 17/06; C23C 8/10

(52) U.S. Cl. 428/605; 427/216

(57) ABSTRACT

A process for the production of surface-oxidized metallic wools or fibres involves dry scraping, with a set of grooved knives or equivalent tools, of a taut metallic wire which is made to slide between two rollers. The process includes regulation of the wire scraping temperature or subsequent heat treatment of the wire after cutting, to obtain controlled surface oxidation of the wool. The products obtained are useful as basic materials to prepare supports for catalysts and materials for various applications, such as sensors, catalysts or friction materials. Examples of coating of metallic wools and fibres with oxides, in particular ceramic oxides, for the creation of catalytic composite materials with a metallic core, are disclosed for this type of use.

This invention relates to a process for the preparation of surface-oxidised metallic wools and relevant fibres deriving from them, the products obtained, and their use as catalysts, supports for catalysts, sensors and friction materials. The coating of these products with ceramic oxides can give rise to metallic core composite materials which are useful in various applications, especially in the catalytic field. Wools and fibres deriving from them can be coated later in a separate plant, or immediately after their formation in the same manufacturing plant.

### BACKGROUND TO THE INVENTION

Metallic wools and fibres have high potential for the production of composite materials for use in the catalytic field and for other major applications. In those composite materials, metallic constitutes the core which is coated with materials of different nature, such as ceramic oxides with high surface and porosity.

For the formulation of these composite materials, it is essential to form an interphase that creates continuity between the two different components, because the final material must feature high chemical and mechanical stability besides the other properties. Problems of adherence to the metallic surface of layers of materials of different nature are very important, and can preclude the production of a good finished product. Pre-treatments of the metallic (acid treatment, heat treatment, electrochemical treatment, etc.), designed to attack the surface firstly from a morphological standpoint, by increasing its roughness, and secondly from a chemical standpoint, by creating layers of oxide, are therefore required to make it suitable to receive the growth of the second component.

The development of composite materials for catalytic applications obtained by coating metallic surfaces with ceramic oxide compounds is still very limited. Relatively few examples could be found in the patent and scientific literature, and they are limited to rigid metallic structures or “formed” structures with geometrical shape constraints (e.g. honeycombs, fans, propellers, etc.) which require further processing before they can be used. These structures are not always easily adaptable to the reactors or housings of various shapes and sizes into which they must be introduced to realize the required chemical transformations. They are also expensive, and the finished catalytic system has a high cost due to the nature and processing of the raw material (pre-treatment of the metallic surface and coating process).

### DESCRIPTION OF THE INVENTION

A new process has now been discovered which allows controlled oxidation of metallic wools and fibres during their production, and which produces metallic materials with morphologically and chemically modified surfaces with no need for complex, expensive pre-treatments in view of their coating.

The metallic wools and fibres obtainable by the process according to the invention are suitably corrugated and oxidised at the surface, and can be used as new materials in various fields of application.

The main field of application is the catalysis. Composite materials obtainable according to the invention, suitably coated with porous material, such as ceramic material, can be used directly as catalysts or as supports for active dispersed phases (Pt, Pd, Rh, Ag, Cu, etc.).

The use of catalytic materials obtainable according to the invention is particularly advantageous because these materials improve the thermal control of reactors as a result of more effective heat transfer and easy elimination of the heat produced by highly exothermic reactions. In fact, the thermal conductivity of catalysts with metallic core is much greater than that of conventional ceramic catalysts. Moreover these characteristics make the catalytic systems obtainable with the invention more stable homogeneous under the most severe conditions of use (e.g. catalytic converters), and allow better control of the chemical in terms of selectivity to the desired products. The absence of rigid shape constraints of the metallic fibres and wools also makes the finished materials highly adaptable to the reactors or housings in which they will be positioned.

This invention also relates to the preparation of composite catalytic materials with metallic core obtained by coating the metallic surfaces and the fibres of various nature deriving from them (e.g. stainless steel, steel, aluminium, bronze, brass, copper, zinc, etc.) with a second ceramic oxide material (e.g. silica, silica-alumina, alumina, etc.). To obtain a suitable coating, the metallic wools and fibres must be prepared by oxidising a micrometric thickness layer (50<thickness/nm<150) of their surface of creating an oxide whose nature is associated with the nature of the metallic wool and/or fibre (e.g. ZnO on zinc wool/fibre, Fe₂O₃ on steel wool/fibre, CuO on copper wool/fibre, etc.). The metallic fibre/wool can be oxidised at the step of manufacture of the wools/fibres with an optimised process depending on temperature, time and humidity. The layer of metallic oxide formed produces good adherence and assures of the ceramic oxide component with which the fibre/wool is subsequently coated, allowing continual shift from metallic to ceramic material.

Depending on the nature and properties of the starting wools/fibres, composite materials are prepared by different methods, in particular with sol-gel, sol, deep-coating, or impregnation methods. Depending on some parameters which can be controlled during the preparatory step, the layer of coating ceramic is more or less thick and homogeneous. The coating of the metallic surface with the ceramic oxide can be homogeneous or non homogeneous. By controlling the heterogeneity of the coating, new “rosary catalysts” can be obtained which have catalytic zones coated with ceramic oxide, and bare metallic zones able to transfer heat to the surrounding reaction fluid, on the same fibre. The composite materials obtained have surfaces with chemical, morphological and structural properties typical of ceramic oxide materials; in other words, they are microcrystalline and have a large surface area and porosity. These properties make the materials suitable for use mainly as catalysts or supports for active catalytic phases.

The invention is particularly advantageous in a variety of fields, especially:

in the environmental and energy field, where composite catalytic materials with a metallic core can be useful to eliminate pollutant compounds in exhaust gases (e.g. catalytic converters for motor vehicles), and to produce energy for industrial or domestic use in processes of total combustion of fossil fuels (catalysts for flameless boilers operating on a catalytic combustion system);

applications in the field of industrial chemistry relate to exothermic chemical processes, in which better temperature control means better kinetic control of the reaction and greater stability of the catalyst;

in the field of sensors for the detection of toxic and/or dangerous gases which use metallic materials coated with thin layers of active material, creating active oxide films (SnO₂, Ga₂O₃, V₂O₅, etc.);

in the field of non-asbestos friction materials; the oxidised metallic fibres can be coated with suitable resins, to produce friction materials to be used in the manufacture of vehicle brake pads and clutches and other similar applications.

For catalytic uses, the high thermal conductivity of the metallic that constitutes the core of the catalytic materials formed allows elimination of the heat developed by the reactions, reducing the stresses on the catalytic material, which can work for longer time (increased durability) with more controlled selectivity. In fact, the high local temperature that can be reached during the exothermic reaction may lead to transformation of the active phase present on the surface of the catalyst (sintering), with loss of catalytic activity. Temperature also plays an important role in the kinetics of the single reactions which can take place on the catalyst bed, or more generally in the reactor, and consequently in the selectivity of the process. Rapid elimination of evolved heat not only improves catalytic performance but also preserves the structure of the catalyst over time.

The process according to the invention for the production of metallic wools with a controlled degree of surface oxidation consists of dry scraping, with a set of grooved tools or knives, a taut metallic wire made to slide between two rollers, characterised in that said process includes regulation of the wire-scraping temperature to obtain controlled oxidation of the wool.

The metallic wire scraping temperature is maintained at between approx. 200 and 700° C.

In this way, oxidation percentages of between 0.1% and 0.3% w/w can be generated, corresponding to oxide thicknesses ranging between approx. 10 and 120 nm.

The metallic wire, before cutting, is preferably made to slide on wire guides, with temperature regulation of both the wire guides and the air in the cutting zone.

The composition of the air in the cutting zone is modified by varying, for example, the water content from 0 to 7% and the oxygen content to 5 and 30% v/v.

The metallic wire is preferably made to advance at a constant speed, typically between 30 and 90 metres/minute.

If, due to the nature of the material, controlled oxidation cannot be completely performed in the cutting zone, oxidation can be performed or completed in the same plant, downstream of scraping, by treatment at a controlled temperature with blowing of air having a defined humidity level.

The metallic wire normally has a diameter of between approx. 3.25 and approx. 3.40 mm, said grooved knives are preferably made of K 100 steel with between 30 and 250 grooves per inch, and the wire is scraped to a diameter of 0.6 mm.

The material used to make the metallic wire can be chosen, according to the fields of use, from among the group constituted by aluminium, steel, stainless steel, copper, brass, zinc and other metallics or alloys.

According to a preferred form of embodiment of the process according to the invention, the wool obtained by scraping said metallic wire can be conveyed to a metallic-bladed mill which chops it into fibres 500-5.000 microns long.

The wool and the fibres deriving from it can be coated with the second component subsequently in another plant, or immediately after their formation in the same manufacturing plant. After scraping, the surface-oxidised metallic wire can be made to slide in baths containing ceramic oxide suspensions of a defined nature and concentration, or sprayed continuously with similar suspensions, to coat it with oxide material. Said second oxide component fixes to the newly-formed metallic oxide, which acts as interface between the metallic and the second oxide. On completion of the cycle, the composite material created is dried and possibly calcined.

The metallic wire coatings can have an homogeneous thickness or an non homogeneous coating with bare metallic areas and areas covered with ceramic, giving rise to “rosary” materials.

The invention is illustrated in greater detail by the following example.

### EXAMPLE

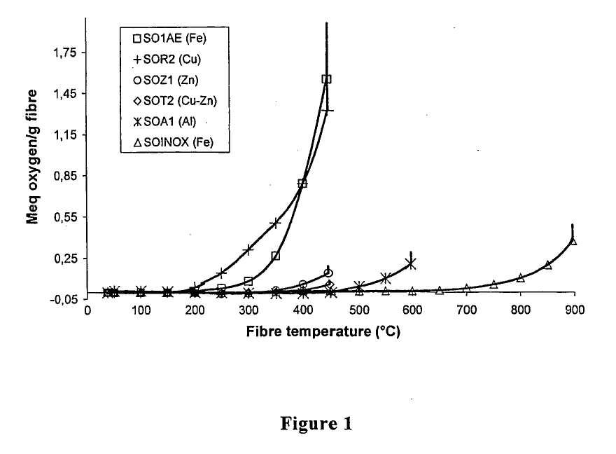

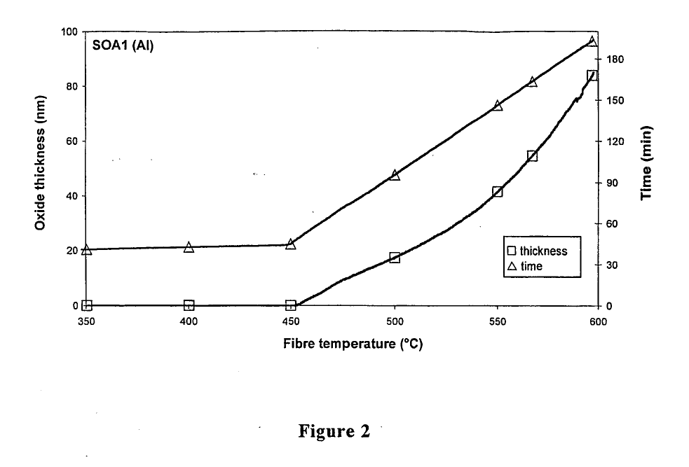

The results obtained with metallic fibres deriving from various kinds of metallic wool (aluminium, steel, stainless steel, copper, brass and zinc), on the basis of optimised modification of their surfaces by creating thin layers of oxides, are shown in Tables 1-2 and FIGS. 1-2.

Table 1 shows the nature of the fibres and the code numbers given to them.

TABLE 1
METALLIC MATERIALS IN FIBRES
DERIVED FROM METALLIC WOOLS

| CODE | MATERIALS |
|---|---|
| SOA1 | Aluminium fibre |
| SO1AE | Steel fibre |
| SOR2 | Copper fibre |
| SOT2 | Brass fibre |
| SOZ1 | Zinc fibre |
| SOINOX | Stainless steel fibre |

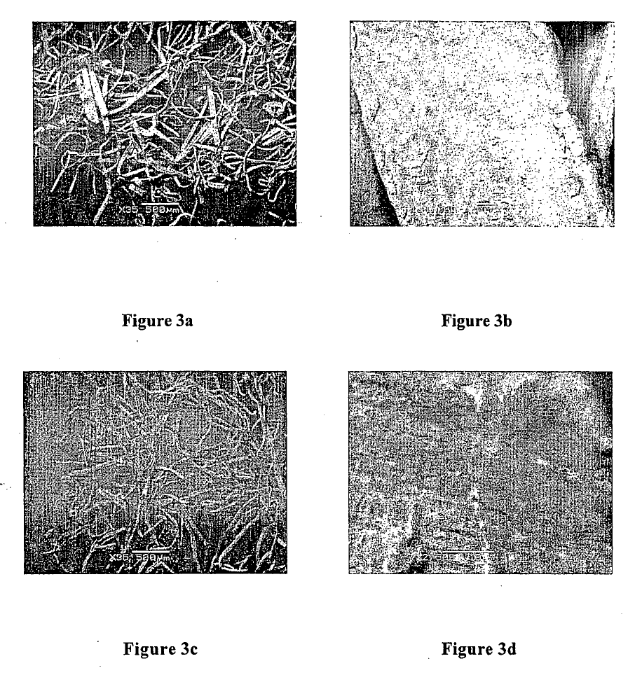

FIGS. 3a-3d are scanning electron microscope microphotographs of a steel wool (SO1AE, Table 1). Two enlargements have been chosen: panoramic, to give an idea of the shape and morphology of the fibres obtained from the metallic wools, and greatly enlarged, to show the surface roughness of the fibres caused by the mechanical and thermal stresses undergone during formation. FIGS. 3a and 3b show the fibre in its original state, while FIGS. 3c and 3d show the oxidised fibre.

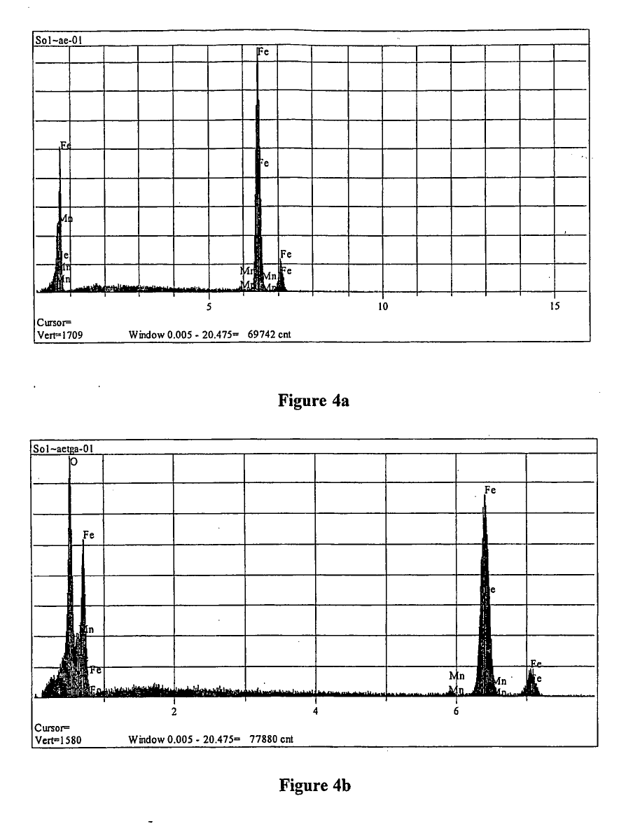

At the same time microanalyses (SEM-EDS=scanning electron microscopy with energy-dispersive X-ray spectroscopy) were performed before (FIG. 4a) and after (FIG. 4b) oxidising treatment of the SO1AE fibre. The absence (FIG. 4a) and presence (FIG. 4b) of the oxygen peak are obvious.

FIG. 1 shows the results obtained with oxidation tests performed in a thermogravimetric analyser (TGA) under controlled time and temperature conditions. In particular, FIG. 1 shows the quantity of oxygen adsorbed, depending on the temperature of the fibre onto which an airstream is directed during the test. The thermogravimetric (TGA) measurements were performed in an airstream with the following conditions:
1) Isotherm at 40° C. for 30 min. in airstream;
2) Linear heating ramp from 40° to 450° C., 600° C. or 900° C. at 30° C./min. in airstream;
3) Isotherm at 450° C., 600° C. or 900° C. for 30 min. in airstream.

The surface oxidation process is obviously activated by temperature, and begins at different times, according to the nature of the fibre. Surface oxidation begins at much lower temperatures for copper and steel than for zinc, brass, stainless steel and aluminium. The different shape of the thermogravimetric curves clearly shows that the kinetics of oxidation, proceeds with very different activation energy depending on the nature of the fibre.

Table 2 shows the temperatures required to obtain surface oxidation of the fibre amounting to 0.1% in weight (T_{0.1%}), together with the quantity of oxygen adsorbed at those temperatures.

TABLE 2
OXIDATION TEMPERATURES (T_{0.1%}) RELATING TO
OXIDATION OF 0.1% OF THE METALLIC FIBRES EVALUATED
BY THERMOGRAVIMETRIC ANALYSIS (TGA)

| | | | Data | | |
|---|---|---|---|---|---|
| | | Experi- | calculated | | |
| | | mental | Oxygen/ | | |
| | | data | metallic | | |
| | | Oxygen | equivalent | Oxidised | Assumed |
| | T_{0.1%} | adsorbed | ratio^{a} | metallic | stoichi- |
| CODE | (° C.) | (meq/g_{fibre}) | (molar %) | (molar %) | ometry |
| SOA1^{b} | 482.8 | 0.0297 | 0.0800 | 0.0533 | Al₂O₃ |
| SO1AE | 220.6 | 0.0188 | 0.1051 | 0.0700 | Fe₂O₃ |
| SOR2 | 180.3 | 0.0126 | 0.0798 | 0.0798 | CuO |
| SOT2 | 387.3 | 0.0126 | 0.0810 | 0.0810 | MO^{c} |
| SOZ1 | 348.0 | 0.0123 | 0.0809 | 0.0809 | ZnO |
| SOINOX^{d} | 668.7 | 0.0191 | 0.0515 | 0.0343 | Cr₂O₃ |

^{a}The main metallic constituent of each fibre was considered (see Table 1).
^{b}For fibre SOA1, the heating ramp was extended to 600° C. (step 2), with isotherm at 600° C. (step 3).
^{c}M = Cu, Zn.
^{d}For the SOINOX fibre, the heating ramp was extended to 900° C. (step 2), with isotherm at 900° C. (step 3).

The quantity of oxygen adsorbed was experimentally determined (meq_{oxygen}/g_{fibre}); this value can be elaborated to determine the quantity of oxide formed as a percentage of the starting metallic (% w/w), on the basis of the assumed stoichiometry for the oxide in formation. As will be seen, for copper and steel fibres the quantity of the oxide formed is more than one order of magnitude greater than for other metallic fibres which are more difficult to oxidise.

On the basis of the TGA results (quantity of oxygen adsorbed according to time and temperature of treatment) and values of surface areas of the fibres, the thickness of the oxide layer created can be calculated. The example given in FIG. 2 shows the kinetics of formation the Al₂O₃ on the surface of the aluminium fibre, evaluating the growth of the oxide thickness. In particular, FIG. 2 shows the thickness of the oxide created (Al₂O₃) on the surface of the SOA1(Al) fibre, depending on temperature of the oxidation treatment.

As will be seen from FIG. 2, Al₂O₃ thicknesses of up to approx. 20 nm are obtained. For the other fibres but stainless steel, the layer can be much thicker because they are easier to oxidise, and their oxidation starts at lower temperature with lower activation energy (as shown in FIG. 1).

It is therefore possible to create a layer of oxide of the required height for each fibre by optimising the time, temperature, and humidity of the oxidising treatment performed. Complete coating of the surface of the metallic fibre with a nanometric layer of oxide is useful to create the interphase between the metallic and a second component (e.g., a ceramic oxide) which will coat the metallic fibre, giving rise to the future final composite material.

The fibres with the surface oxidised in a controlled way were coated with porous ceramic material (e.g. alumina, silica, zirconia, silica-alumina, etc.), and different methods of preparation and deposit of the ceramic material (e.g. the “sol”, “sol-gel” or “impregnation” method) were compared.

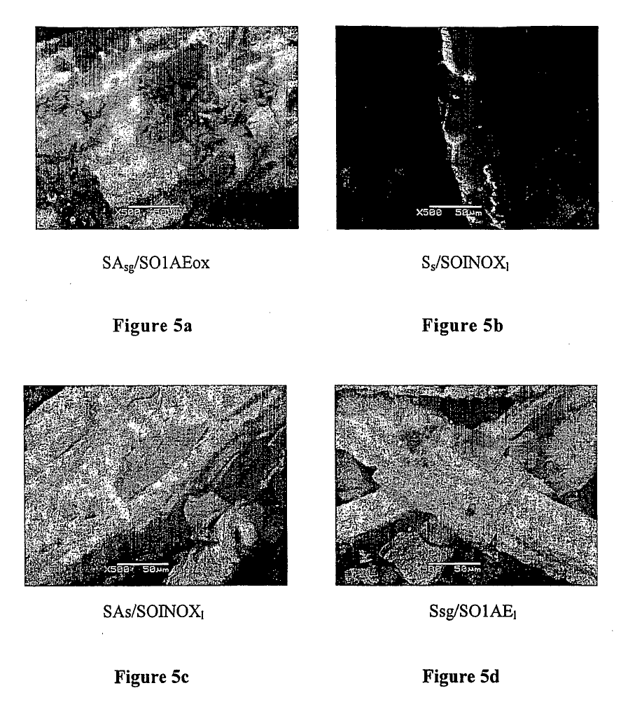

FIG. 5(a-d) shows scanning electron microscope microphotographs of some metallic fibres coated with oxides of different nature which were prepared by the various methods used: FIG. 5a, the SO1AE fibre (steel fibre), surface-oxidised and coated with silica-alumina (SA) by the sol-gel method; FIG. 5b, the SOINOX fibre (stainless steel fibre), only washed and coated with silica—(S) by the sol method; FIG. 5c, the SOINOX fibre (stainless steel fibre), only washed, and coated with silica-alumina (SA) by the sol method; and finally FIG. 5d, the SO1AE fibre (steel fibre), only washed, and coated with silica (S) by the sol-gel method. In all cases the ceramic phase deposited on the metallic fibres, coating them more or less homogeneously, is clearly visible.

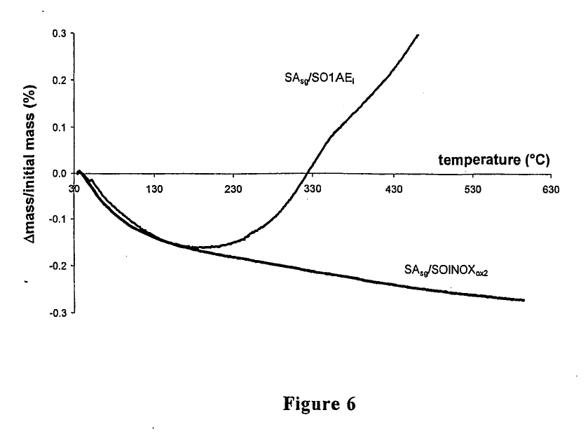

The formation of ceramic phases deposited on the materials has been proved by thermogravimetric analyses conducted with programmed temperatures (10° C./min. in the temperature range 40° to 600° C.) in an air atmosphere. FIG. 6 shows two examples of SO1AE fibres washed and coated with silica alumina (SA) by the sol-gel method (SA_{sg}/SO1AE_{I}) and SOINOX oxidised and coated with silica-alumina (SA) by the sol-gel method (SA_{sg}/SOINOX_{I}); in both cases a major decrease in mass is observed in the initial temperature range (50-150° C.), this being typically observed in porous ceramic materials which lose the water present in their pores and on their surface. The thermogravimetric curves (profiles) of the two univated fibres were completely flat in the same temperature range (see FIG. 1). The behaviour of the two fibres differs at higher temperatures (>200° C.). The phenomenon of increasing mass prevails on steel fibre due to oxidation of the fibre (this phenomenon starts from the surface and enters in to the mass of metallic material), whereas on stainless steel fibre, no oxidation is yet observed at these temperatures and the water loss process continues, though very slightly.

As a result of the ceramic phase coating of the metallic fibres, the composite materials created developed a large surface area. Table 3 shows the values of the specific surface area (measured with nitrogen at temperature of −196° C.) for some stainless steel fibres coated with silica-alumina by the sol-gel method. The surface area values are higher for the material created from oxidised fibre than from fibre which is merely washed, as expected. For the materials shown in Table 3, the percentage in weight of ceramic compared with metallic fibre, and the corresponding thickness of ceramic developed, assuming an homogeneous deposit on the metallic surface, are also shown.

TABLE 3
SURFACE AREAS AND EXTENT OF FIBRE
COATING WITH CERAMIC OXIDE

| CODE OF | BET TEST RESULTS | | |
|---|---|---|---|
| COATED | Surface area | Ceramic/Fibre | Thickness of |
| MATERIALS | (m²/g) | (mass/mass) | oxide (nm) |
| SAsg/SOINOX₁ | 12.4 | 0.023 | 766 |
| SAsg/SOINOXₒₓ₋₁ | 29.0 | 0.054 | 1800 |
| SAsg/SOINOXₒₓ₋₂ | 22.9 | 0.043 | 1433 |

1. Process for the production of surface-oxidised metallic wools or fibres which involves dry scraping, with a set of grooved knives or equivalent tools, of a taut metallic wire which is made to slide between two rollers, characterised in that said process includes regulation of the wire-scraping temperature to obtain controlled surface oxidation of the wool.

2. Process as claimed in claim 1, characterised in that the metallic wire scraping temperature is maintained at between approx. 200 and 700° C.

3. Process as claimed in claim 1, characterised in that surface oxidation of the wire can be completed downstream of scraping by heat treatment at a suitable temperature in a humidity-controlled atmosphere for a given time.

4. Process as claimed in claim 2, characterised in that it generates oxidation percentages of between 0.1% and 0.3% w/w, which correspond to oxide thicknesses ranging between approx. 10 and 120 nm.

5. Process as claimed in claim 2, wherein said metallic wire, before cutting, is slid on wire guides and subjected to an airstream, characterised in that the temperature of the wire guides and the air in the cutting zone is regulated.

6. Process as claimed in claim 5, characterised in that the composition of the air at the cutting point is modified by varying the water content from 0 to 7% and the oxygen content to 5 and 30% v/v.

7. Process as claimed in claim 1, characterised in that said metallic wire is made to advance at a constant speed of between 30 and 90 metres/minute.

8. Process as claimed in claim 1, characterised in that said metallic wire has a diameter of between 3.25 and 3.40 mm and said grooved knives are made of K 100 steel with between 30 and 250 grooves per inch.

9. Process as claimed in claim 1, characterised in that said metallic wire is scraped to a diameter of 0.6 mm.

10. Process as claimed in claim 1, wherein said metallic wire is made of aluminium, steel, stainless steel, copper, brass, zinc or other metallics or alloys.

11. Process as claimed in claim 1, characterised in that the wool obtained by scraping said metallic wire is sent to a metallic-bladed mill which chops it into fibres 500-5.000 microns long.

12. Metallic wool or fibres obtainable from process claimed in claim 1.

13. Use of the metallic wool or fibres claimed in claim 11 to prepare a support for active catalytic phases, catalysts, sensors or non-asbestos friction materials.

14. Process for the preparation of metallic fibres at least partly coated with a porous oxide layer, which includes treatment of a solution containing molecular precursors of an oxide compound containing the surface-oxidised metallic fibres described in claim 12 with a mineral acid to obtain oxide “sols”, subsequent filtration, drying and final calcining.

15. Process for the preparation of metallic fibres at least partly coated with a porous oxide layer, which includes gelling of a solution containing molecular precursors of an oxide compound and a template containing the surface-oxidised metallic fibres described in claim 12, subsequent filtration, drying and final calcining.

16. Process for the preparation of metallic fibres at least partly coated with a porous oxide layer, which includes treatment of the surface-oxidised metallic fibres described in claim 12 with an aqueous suspension containing an oxide, subsequent filtration and drying.

17. A process as claimed in claim 14 wherein the precursor compound is selected from alkoxides of aluminium, titanium, silicon, or from silica, zirconia or alumina.

18. Metallic fibres at least partly coated with a layer of oxide, obtainable from the process claimed in.

19. Metallic fibres as claimed in claim 18, wherein the coating is discontinuous.

20. Metallic fibres as claimed in claim 18, wherein the oxide is the ceramic type.
